(19) United States
(12) Patent Application Publication
(10) Pub. No.: US 2025/0358163 A1
(43) Pub. Date: Nov. 20, 2025

(54) METHODS FOR TRANSMITTING UPLINK OTFDM SYMBOLS AND TRANSMITTERS THEREOF

(71) Applicant: WISIG NETWORKS PRIVATE LIMITED, Madinaguda, Hyderabad (IN)

(72) Inventors: SaiDhiraj Amuru, Manikonda, Hyderabad (IN); Koteswara Rao Gudimitla, Srikalahasti, Andhra Pradesh (IN); Sibgath Ali Khan Makandar, Sangareddy, Telangana (IN); Sakshama Ghoslya, Jaipur, Rajasthan (IN); Kiran Kumar Kuchi, Madinaguda, Hyderabad (IN)

(21) Appl. No.: 18/872,339

(22) PCT Filed: Jun. 7, 2023
(86) PCT No.: PCT/IN2023/050536

§ 371 Date: Dec. 6, 2024

(30) Foreign Application Priority Data
Jun. 7, 2022 (IN) 202241032638

(51) Int. Cl. H04L 27/26; H04L 5/00; H04W 72/21

(52) U.S. Cl. CPC H04L 27/2634; H04L 5/0051; H04L 27/2607; H04W 72/21

(57) ABSTRACT

Embodiments of the present disclosure relate methods for generating and transmitting uplink Orthogonal time frequency-division multiplexing (OTFDM) symbols and the transmitters thereof. The method comprising time-multiplexing by one or more transmitters, at least one of a physical uplink control channel (PUCCH) sequence, a Physical Uplink Shared Channel (PUSCH) sequence and a reference sequence (RS) to generate a multiplexed sequence. The multiplexed sequence is processed to generate one or more PUCCH-PUSCH OTFDM symbols. Also, a method of generating and transmitting one or more PUCCH-PUSCH OTFDM slots, one or more PRACH OTFDM symbols and an uplink frame id provided.

### CROSS-REFERENCE TO RELATED APPLICATIONS

This application claims priority from the Indian Provisional Patent Application Number 202241032638, filed on 7 Jun. 2022, the entirety of which are hereby incorporated by reference.

### TECHNICAL FIELD

Embodiments of the present disclosure are related, in general to communication, but exclusively relate to methods and systems for generating and transmitting OTFDM symbol in an uplink.

### BACKGROUND

3GPP (3rd Generation Partnership Project) has developed 5G-NR standards to support use cases like eMBB, URLLC, MMTC. To support multiple access OFDMA has been agreed to use in current 5G-NR. However, in previous standards different Multiple access techniques have been studied and used, like in 2G TDMA, 3G is based on CDMA and relied on OFDMA. OFDM, in spite of many of its attractive properties, has a critical drawback i.e., low power-amplifier efficiency (low energy efficiency).

The communications latency is fundamentally limited by the delay before a transfer of data begins following an instruction for its transfer. This delay is equal to the duration of a “slot” which is a basic unit of information transmission that comprises of data/control and reference signals. A slot in OFDM systems comprises of multiple data symbols and one or more reference symbols. 4G uses 0.5 ms slot and 5G NR specifications allow URLLC using 0.125 ms. In order to achieve low latency 5G NR uses mini slots where the duration of the slot is two OFDM symbols. To achieve Extremely Low Latency Communication (ELLC) it is preferable to use a single OFDM symbol to transmit the information. Basic OFDM allows frequency multiplexing of reference signal and data/control within one OFDM symbol. Our chief aim is to use high energy efficiency waveform such as DFT-S-OFDM (it is a variant of OFDM with low-PAPR and is used in both 4G and 5G); this waveform requires a dedicated OFDM symbol for the transmission of RS and an additional symbol for data, thus resulting in two symbols duration (In conventional DFT-S-OFDM, RS is not time multiplexed with data in one OFDM symbol since this multiplexed RS does not offer reliable estimation of the channel impulse response). The RS is required for the purpose of estimating the channel state information (CSI) and subsequent equalization of data symbol. This two-symbol structure not only doubles the latency (compared to single symbol case), but also has a higher RS overhead i.e., 50%. There is a need for a new type of waveform that allows one shot transmission with flexible RS overhead and high-power efficiency. 6G Mobile Communication System requires a method of information transmission and that offers extremely low latency, very high data rate, and very high-power efficiency.

There is a need for a waveform technology that not only addresses this critical issue of improving energy efficiency but also achieves extremely low latency. Current 5G standards uses slot structure, where user data is transmitted in series of OFDM symbols. A typical slot structure comprises of one or more data symbols and one or more reference symbols.

### SUMMARY

The shortcomings of the prior art are overcome and additional advantages are provided through the provision of method of the present disclosure.

Additional features and advantages are realized through the techniques of the present disclosure. Other embodiments and aspects of the disclosure are described in detail herein and are considered a part of the claimed disclosure.

In one aspect of the present disclosure a method for transmitting one or more PUCCH-PUSCH Orthogonal time frequency-division multiplexing (OTFDM) symbols is disclosed. The method comprising time-multiplexing, by one or more transmitters, at least one of a physical uplink control channel (PUCCH) sequence, a Physical Uplink Shared Channel (PUSCH) sequence and a reference sequence (RS) to generate a multiplexed sequence. Also, the method comprises generating, by the one or more transmitters, one or more PUCCH-PUSCH OTFDM symbols by processing the multiplexed sequence.

In another aspect of the present disclosure a method for transmitting a PUCCH-PUSCH Orthogonal time frequency-division multiplexing (OTFDM) slot is provided. The method comprising time-multiplexing, by one or more transmitters, at least one of one or more PUCCH-PUSCH OTFDM symbols, one or more PUCCH OTFDM symbols and one or more PUSCH OTFDM symbols to generate an Orthogonal time frequency-division multiplexing (OTFDM) slot.

In yet another aspect of the present disclosure a method for transmitting one or more PRACH Orthogonal time frequency-division multiplexing (OTFDM) symbols is provided. The method comprises transforming, by one or more transmitters, at least PRACH sequence using a Discrete Fourier Transform (DFT) to generate a transformed sequence. Also, the method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed sequence. Further, the method comprises mapping the extended bandwidth transformed multiplexed sequence with at least one of localized and distributed subcarriers to generate a mapped extended bandwidth transformed sequence, and shaping the mapped extended bandwidth transformed multiplexed sequence using a filter to obtain a shaped extended bandwidth transformed sequence. Furthermore, the method comprises performing an Inverse Fast Fourier Transform (IFFT) on the shaped extended bandwidth transformed multiplexed sequence to produce a time domain sequence and processing the time domain sequence to generate the one or more PRACH OTFDM symbols.

In yet another aspect of the present disclosure a method for transmitting an uplink frame is provided. The method comprising multiplexing, by one or more transmitters, at least one of: one or more PRACH OTFDM symbols/slot and one or more PUCCH-PUSCH OTFDM slots to generate at least one uplink signal associated with a beam.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of device or system and/or methods in accordance with embodiments of the present subject matter are now described, by way of example only, and with reference to the accompanying figures, in which:

FIG. 1A shows a block diagram of an OTFDM uplink transmitter, in accordance with an exemplary embodiment of the present disclosure;

FIG. 1B shows a block diagram of an OTFDM symbol generating unit, in accordance with an embodiment of the present disclosure;

FIG. 1C shows a block diagram of a processing unit of the OTFDM symbol generating unit as shown in FIG. 1B, in accordance with an embodiment of the present disclosure;

FIG. 1D shows a block diagram of a PRACH OTFDM uplink transmitter, in accordance with an embodiment of the present disclosure;

FIG. 1E shows a block diagram of a PRACH OTFDM uplink transmitter, in accordance with another embodiment of the present disclosure;

FIGS. 2A-2E shows an illustration of different uplink OTFDM symbols in accordance with an embodiment of the present disclosure;

FIG. 3A shows an illustration of RS-data multiplexed symbol structure for n transmitters;

FIG. 3B shows symbol structure where RS in multiple transmitters having only pre-fix;

FIG. 3C shows symbol structure where RS in multiple transmitters having only post-fix;

FIG. 3D shows an illustration of generating user specific RS with cover code;

FIG. 4A shows a symbol with two RS blocks at the symbol boundaries and data in the middle of OFDM symbol;

FIG. 4B shows a Symbol with RS with pre-fix and post-fix at ¼th and ¾th positions of OFDM symbol;

FIG. 4C shows a Symbol with RS with pre-fix and post-fix starting at 0th and ½th positions of OFDM symbol;

FIG. 4D shows a Symbol with two RS blocks at the symbol boundaries, one in the middle for channel estimation;

FIG. 5 shows an illustration of uplink signalling;

FIG. 6A shows a block diagram of a PRACH receiver; and

FIG. 6B shows an illustration contiguous repetitions of symbols in of UL PRACH transmitter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

The present disclosure provides a waveform technology that not only addresses this critical issue of improving energy efficiency but also achieves one of the major goals of future wireless communication systems i.e., extremely low latency. Current 5G standards uses slot structure, where user data is transmitted in series of OFDM symbols. A typical slot structure comprises of one or more data symbols and one or more reference symbols.

Embodiments of the present disclosure provides a new waveform which allows uplink channels PRACH, PUCCH, PUSCH to be transmitted with low PAPR, high PA efficiency, low latency using multiple antenna ports or beams. The embodiments illustrate how low latency is obtained from entire system operation point of view.

Embodiments of the present disclosure provides a new type of waveform that allows time division multiplexing of data/control and RS within a single OFDM symbol (TDM within a OFDM Symbol). The generated symbol is referred to as orthogonal time frequency division multiplexing (OTFDM) symbol, which is designed for information exchange taking place in one shot transmission. The duration of the OFDM symbol (or subcarrier width) is to meet the overall latency requirement.

In an uplink (UL) transmission, a communication system or transmitter uses a method of TDM of user data/control/RS and also common channels such as PRACH, PUCCH, and PUSCH using OTFDM waveform. However, multiple services and multiple numerologies can be frequency multiplexed using FDM based on the BWP concept that uses WOLA/filtering for frequency multiplexing of these services.

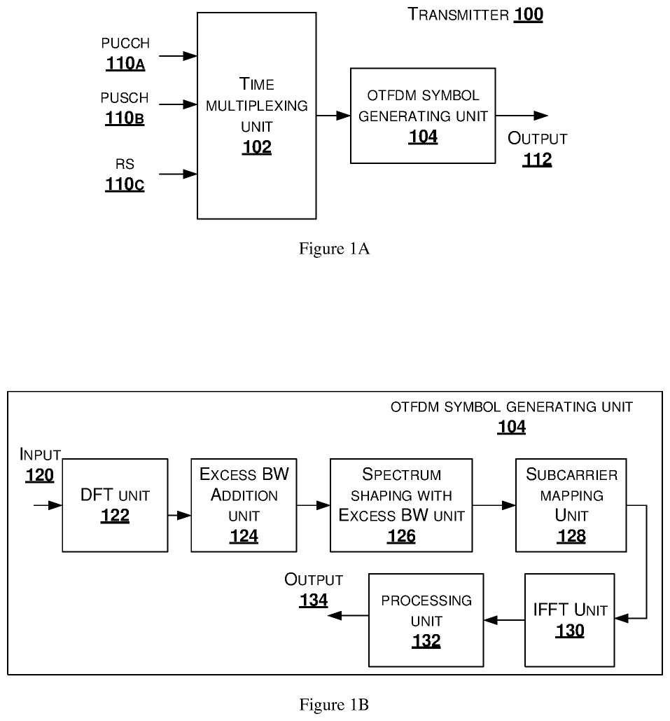

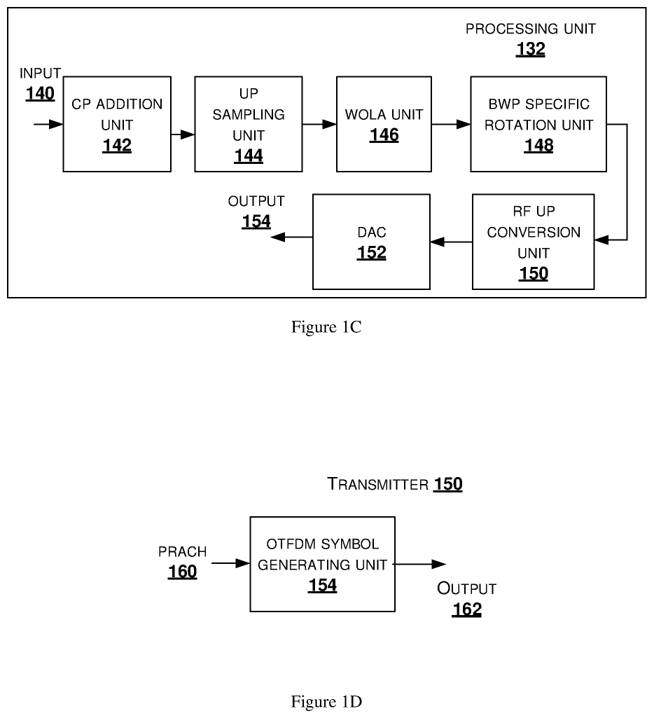

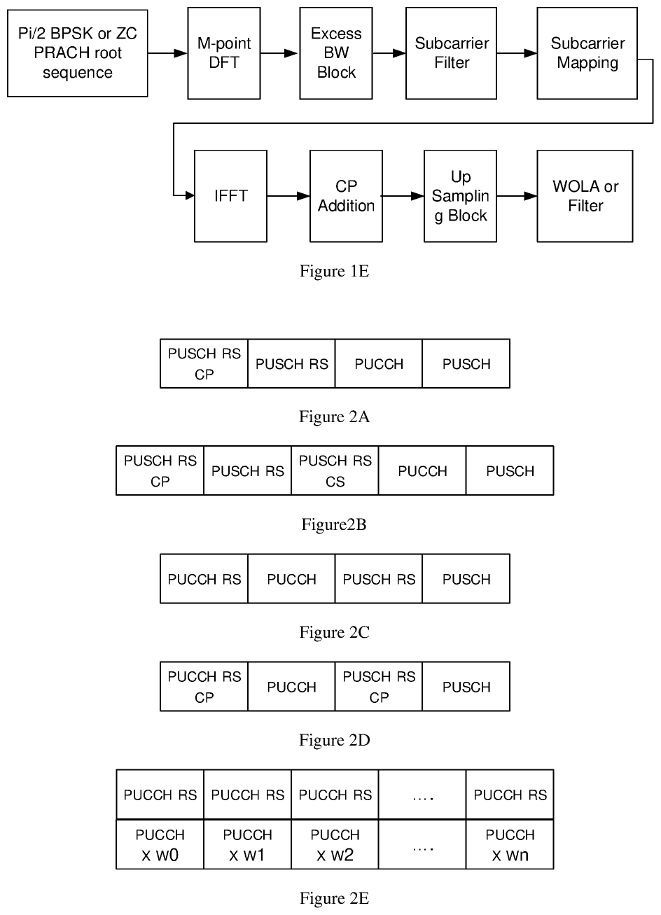

FIG. 1A shows a block diagram of an OTFDM communication system, in accordance with an exemplary embodiment of the present disclosure. The OTFDM communication system is referred to as a OTFDM transmitter or a transmitter or an uplink transmitter.

As shown in the FIG. 1A, the transmitter 100 comprises a time multiplexing unit 102 and an OTFDM symbol generating unit 104. The time multiplexing unit 102 is also referred as a time multiplexer or multiplexer or time division multiplexer or TDM. Also, the transmitter 100 comprises a plurality of antennas which is referred to as one or more antennas. The one or more transmitters is one of spatially multiplexed transmitters and uplink users. The OTFDM symbol generating unit 104 is also referred as OTFDM symbol generator or symbol generator.

In an embodiment, the time multiplexer 102 multiplexes at least one of a physical uplink control channel (PUCCH) sequence 110A, a Physical Uplink Shared Channel (PUSCH) sequence 110B, and a RS sequence 110C to generate a multiplexed sequence. The multiplexed sequence is also referred to as time multiplexed sequence or TDM sequence or pre-DFT symbols. The symbols shown in FIG. 2A-2E are the multiplexed sequences obtained using time multiplexer 102.

The OTFDM symbol generating unit 104 generates one or more PUCCH-PUSCH OTFDM symbols using the multiplexed sequences. In an embodiment, as the multiplexed sequence is obtained using the at least one of the PUCCH sequence, the PUSCH sequence and the RS sequence, the generated symbol is referred as uplink multiplexed Orthogonal time frequency-division multiplexing (OTFDM) symbol or multiplexed OTFDM symbol or uplink multiplexed OTFDM symbol.

In an embodiment, the multiplexed sequence is fed to the OTFDM symbol generating unit 104, to generate one or more PUCCH-PUSCH OTFDM symbols specific to a particular antenna. The symbols generated are transmitted by the corresponding antennas.

FIG. 1B shows a block diagram of an Orthogonal time frequency-division multiplexing (OTFDM) symbol generating unit, in accordance with an embodiment of the present disclosure. As shown in the FIG. 1B, the OTFDM symbol generating unit 104 comprises a Discrete Fourier Transform (DFT) unit 122, an excess BW addition unit 124, a spectrum shaping with excess BW unit 126, a sub-carrier mapping unit 128, an inverse Fast Fourier transform (FFT) unit 130 and a processing unit 132.

The DFT unit 122 transforms an input 120 i.e. multiplexed sequence using a Discrete Fourier Transform (DFT) to generate a transformed multiplexed sequence.

The excess BW addition unit 124 performs padding operation on the transformed multiplexed sequence i.e. prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero. The values of N1 and N2 may be same or different. The value of N1 and N2 may depend on the excess power that is sent by the transmitter.

The spectrum shaping with excess BW unit 126, also referred as a shaping unit or a filter, performs shaping of the extended bandwidth transformed multiplexed sequence to obtain a shaped extended bandwidth transformed multiplexed sequence or shaped sequence. The filter used for the shaping operation on the extended bandwidth transformed multiplexed sequence is one of a Nyquist filter, square root raised cosine filter, a raised cosine filter, a hamming filter, a Hanning filter, a Kaiser filter, an oversampled GMSK filter and any filter that satisfies predefined spectrum characteristics.

The sub carrier mapping unit 128, also referred as a mapper or a sub carrier mapper or a mapping unit, performs subcarrier mapping on the shaped extended bandwidth transformed multiplexed sequence or shaped sequence with at least one of localized and distributed subcarriers to generate a mapped extended bandwidth transformed multiplexed sequence. In an embodiment, the distributed subcarrier mapping includes insertion of zeros in to the extended bandwidth transformed multiplexed sequence.

The IFFT unit 130 performs inverse IFFT on the shaped extended bandwidth transformed multiplexed sequence to produce a time domain sequence. The time domain sequence is processed by the processing unit 132 to generate an output 134, i.e. one or more PUCCH-PUSCH OTFDM symbols also referred as one or more OTFDM symbols.

FIG. 1C shows a block diagram of a processing unit of the OTFDM symbol generating unit 104 as shown in FIG. 1B, in accordance with an exemplary embodiment of the present disclosure. As shown in FIG. 1C, the processing unit 132 comprises a cyclic prefix (CP) addition unit 142, an up sampling unit 144, a weighted with overlap and add operation (WOLA) unit 146, a bandwidth parts (BWP) specific rotation unit 148, a RF up-conversion unit 150, and a digital to analog converter (DAC).

The processing unit 132 processes the time domain sequence to generate an OTFDM symbol. The time domain sequence is generated by the IFFT unit 130 of the OTFDM symbol generating unit. The input 140 to this processing unit is the time domain sequence. The processing comprises performing at least one of a symbol specific phase compensation, an addition of symbol cyclic prefix using the CP addition unit 142, up sampling using the up-sampling unit 144, addition of symbol cyclic suffix, windowing, weighted with overlap and add operation (WOLA) using the WOLA unit 146, bandwidth parts (BWP) rotation using BWP specific rotation unit 148, an additional time domain filtering, sampling rate conversion to match DAC rate, frequency shifting on the time domain waveform using RF up conversion unit 150 and converting the same into analog using the DAC 152 to generate the output 154, which is one or more PUCCH-PUSCH OTFDM symbols, in an embodiment. In an embodiment, the generated output is referred as UL multiplexed OTFDM symbol. The output i.e. one or more PUCCH-PUSCH OTFDM symbols or OTFDM symbols offers low peak to average ratio (PAPR).

One embodiment of the present disclosure is multiple input multiple output (MIMO) with Pre-DFT RS for PUCCH with one symbol. The transmitter as shown in FIG. 1A which transmits a OTFDM symbol, comprising of at least one of at least one a data and at least one RS are transmitted in the same OFDM symbol. The at least one data is referred as the control data. The at least one RS is referred as the RS. The data and the RS are multiplexed before DFT-precoding in the time domain. Data and RS are sequence of samples. The position of RS may be in the center or starting or ending of the OTFDM symbol. This kind of RS may be referred as long/main/localized RS. To support better channel estimation either cyclic pre-fix (RS-CP) or cyclic post-fix (RS-CS) or both pre-fix and post-fix will be added to the RS in the time domain. The sequence to be used as RS is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes. The frequency spectrum of RS should be as flat as possible to ensure reliance channel estimation. RS and RS-CP or RS-CS may occupy a portion of resources allocated to the transmitter, which may depend on properties of channel conditions, Excess bandwidth, transmitter allocation size, modulation order, coding rate, and other parameters like impulse response of spectrum shaping filter.

As shown in the FIGS. 2A to 2E, the control data of multiple transmitters/UEs can be multiplexed on the same time frequency resources. In order to minimize the intra user interference across these multiplexed UEs, the time domain RS for these UEs should be orthogonal. Each UE can be allocated with a dedicated antenna port, such that the RS across these UEs are orthogonalized. The orthogonality across RS can be established through CDM, FDM, TDM.

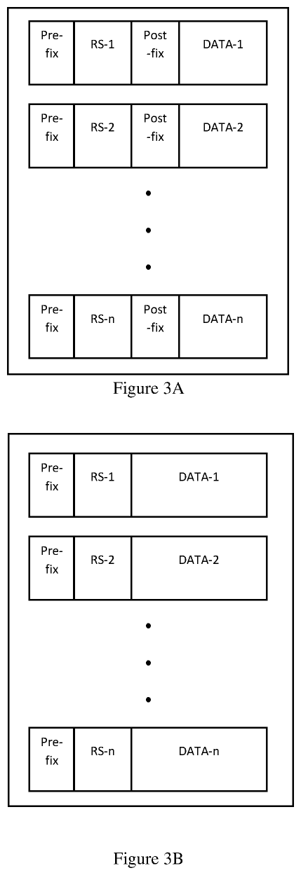

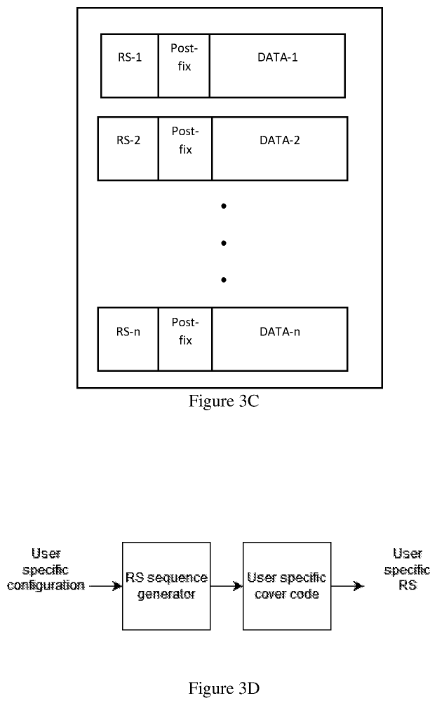

One embodiment of the present disclosure is RS generation for different transmitters. In one case, the RS sequence for a given transmitter may be obtained by cyclically shifting the base reference sequence. The base sequence has to obtain transmitter specific RS, which may be one of pi/2-BPSK, QPSK, PSK, and ZC sequences. The base sequence generation may depend on the cell ID, transmitter specific ID, symbol index, scrambling ID, antenna port, and slot number. The cyclic shifts to be used for each transmitter is port specific, i.e., the RS that is transmitted on a given port enables the corresponding cyclic shift on the base RS sequence. The cyclic shifts to be used for each transmitter may be one of factor of length of RS sequence, and ceil, floor, or round of the length of the RS sequence, and the number of transmitters to be multiplexed. The symbol structure for the transmitter is shown FIG. 3A. The transmitter specific RS to be used for channel estimation may have either RS-pre-fix or RS-post-fix or both RS-pre-fix and RS-post-fix. FIG. 3B shows symbol structure where RS in multiple transmitters having only RS-pre-fix. FIG. 3C shows symbol structure where RS in multiple transmitters having only RS-post-fix.

One embodiment of the present disclosure is illustration of the method of generating OTFDM symbols. Considering the number of transmitters to be used be 4. The base sequence to be used in generating the RS for multiple transmitters be r(n) of length Nᵣ. The cyclic shifts to be used to generate transmitter specific RS be

$$\{ \frac{{N}_{r}}{2} , \frac{{N}_{r}}{4} , \frac{3 {N}_{r}}{4} , 0 \} ,$$

hence, the RS sequences for transmitter 1, 2, 3, and 4 may be given by:

$$RS for user 1 : {r}_{1} ( n ) = r ( n - \frac{{N}_{r}}{2} ) \to {R}_{1} = circ ( {r}_{1} ( n ) )$$

$$RS for user 2 : {r}_{2} ( n ) = r ( n - \frac{{N}_{r}}{4} ) \to {R}_{2} = circ ( {r}_{2} ( n ) )$$

$$RS for user 3 : {r}_{3} ( n ) = r ( n - \frac{3 {N}_{r}}{4} ) \to {R}_{3} = circ ( {r}_{3} ( n ) )$$

$$RS for user 4 : {r}_{4} ( n ) = r ( n ) \to {R}_{4} = circ ( {r}_{4} ( n ) )$$

$${R}_{i} \times {R}_{i} = I$$

$${R}_{i} \times {R}_{j} = {P}_{i j} - Permutation matrix$$

In another embodiment, RS sequence for different transmitters is generated using a base RS repetitions and transmitter specific cover code. The RS for each transmitter is repeated at least the number of transmitters available. A transmitter specific block wise cover code is applied on the repeated sequence. FIG. 3D shows RS generation with cover code. For a base sequence of length Nᵣ and for Nₜ number of transmitters to be multiplexed, the length of each RS sequence of each transmitter is at least Nᵣ×Nₜ. The transmitter specific block wise cover codes are orthogonal to each other. The RS for each transmitter may be the same sequence obtained from a base sequence or different sequences, and sequences may be pi/2-BPSK, QPSK, PSK, or ZC sequences. The base sequence generation or the transmitter specific sequence may depend on the cell ID, transmitter specific ID, symbol index, scrambling ID, antenna port, and slot number. The block wise spreading codes may be a PN sequence, Hadamard codes or Walsh codes. The block wise spreading code may be obtained from one of m-sequences, PN sequences, Kasami. The transmitter specific RS to be used for channel estimation may have either RS-pre-fix or RS-post-fix or both RS-pre-fix and RS-post-fix.

Let the base sequence of each RS block be r(n) of size Nᵣ, where Nᵣ is the length of RS block to be used to generate RS for each transmitter. The number of transmitters that are multiplexed be Nₜ. Hence, the size of RS for each transmitter is Nᵣ×Nₜ. Considering a two-transmitter case, the length of the RS is 2×Nᵣ. The RS for first transmitter is given by

$${r}_{1} ( n ) = r ( n mod ( {N}_{r} \times 2 ) )$$

Similarly, the RS for the second user is given by

$${r}_{2} ( n ) = r ( n mod ( {N}_{r} \times 2 ) ) {e}^{i π ⌊ \frac{n}{{N}_{r}} ⌋}$$

$$Here , n = \{ 0 , 1 , 2 , 3 , … , {N}_{r} \times 2 \}$$

Here, └ ┘ is a flooring operation, where for a real number x, └x┘ gives the greatest integer, which is less than or equal to x. With this kind of RS structure defined for the two transmitters, the Fourier transform of RS of the first transmitter will occupy the even indices, while the Fourier transform of the RS of the second transmitter will occupy the odd indices.

In another embodiment, considering the orthogonal sequence is obtained using one of the sequences defined above, the block wise cover code for each user is given by b₁(n), and b₂(n) of length Nₜ. With base RS block sequence being r(n), the RS sequence for each is given by

$${r}_{1} ( n ) = {b}_{1} ( ⌊ \frac{n}{{N}_{r}} ⌋ ) r ( n mod ( {N}_{r} \times 2 ) )$$

$${r}_{2} ( n ) = {b}_{2} ( ⌊ \frac{n}{{N}_{r}} ⌋ ) r ( n mod ( {N}_{r} \times 2 ) )$$

Here, └ ┘ is a flooring operation, where for a real number x, └x┘ gives the greatest integer, which is less than or equal to x. In an embodiment, the control payload is processed in a similar way to the conventional 5G system before multiplexing data and RS, which involves code block segmentation (only when needed), the addition of CRC bits, channel coding, rate matching and code block concatenation, scrambling.

One embodiment of the present disclosure is MIMO with Pre-DFT RS for PUCCH with more than one symbols. The communication system or transmitter transmits more than one OTFDM symbols or one or more OTFDM symbols or one or more PUCCH-PUSCH OTFDM symbols. Each of the symbol comprises at least one of at least one a data and at least one RS are transmitted in the same OFDM symbol. The at least one data is referred as the control data. The at least one RS is referred as the RS. The data and the RS are multiplexed before DFT-precoding in the time domain. Additionally, spreading code W(n) is applied on the control data across the multiple symbols.

The modulation alphabets corresponding to the control payload are divided into groups, where the number of groups equals the number of symbols used to transfer the payload. The number of modulation alphabets within each group depends upon the spreading factor of the subsequent spreading process. The spreading factor can be specified using the OCC-Length information element. The spreading factors of 2 and 4 is supported.

The RS sequence for a given transmitter may be obtained by cyclically shifting the base reference sequence. The base sequence has to obtain transmitter specific RS, which may be one of pi/2-BPSK, QPSK, PSK, and ZC sequences. The base sequence generation may depend on the cell ID, transmitter specific ID, symbol index, scrambling ID, antenna port, and slot number. Specifically, the base RS sequence will be a function of symbol index, resulting in different base sequences across the different DFT-s-OFDM symbols or OTFDM symbols.

The cyclic shifts to be used for each transmitter is port specific, i.e., the RS that is transmitted on a given port enables the corresponding cyclic shift on the base RS sequence. Optionally, the cyclic shift of each RS port can also be made a function of Symbol-Index. The cyclic shifts to be used for each transmitter may be one of factor of length of RS sequence, and ceil, floor, or round of the length of the RS sequence, and the number of transmitters to be multiplexed. The symbol structure for the transmitter is shown FIG. 3A. The transmitter specific RS to be used for channel estimation may have either RS-pre-fix or RS-post-fix or both RS-pre-fix and RS-post-fix. FIG. 3B shows symbol structure where RS in multiple transmitters having only RS-pre-fix. FIG. 3C shows symbol structure where RS in multiple transmitters having only RS-post-fix.

One embodiment of the present disclosure is illustration of the method of generating OTFDM symbols. Let the number of transmitters to be used be 4. The base sequence to be used in generating the RS for multiple transmitters be r(n) of length Nᵣ. The cyclic shifts to be used to generate transmitter specific RS be

$$\{ \frac{{N}_{r}}{2} , \frac{{N}_{r}}{4} , \frac{3 {N}_{r}}{4} , 0 \} ,$$

hence, the RS sequences for transmitter 1, 2, 3, and 4 may be given by:

$$RS for user 1 : {r}_{1} ( n ) = r ( n - \frac{{N}_{r}}{2} ) \to {R}_{1} = circ ( {r}_{1} ( n ) )$$

$$RS for user 2 : {r}_{2} ( n ) = r ( n - \frac{{N}_{r}}{4} ) \to {R}_{2} = circ ( {r}_{2} ( n ) )$$

$$RS for user 3 : {r}_{3} ( n ) = r ( n - \frac{3 {N}_{r}}{4} ) \to {R}_{3} = circ ( {r}_{3} ( n ) )$$

$$RS for user 4 : {r}_{4} ( n ) = r ( n ) \to {R}_{4} = circ ( {r}_{4} ( n ) )$$

$${R}_{i} \times {R}_{i} = I$$

$${R}_{i} \times {R}_{j} = {P}_{i j} - Permutation matrix$$

In another embodiment, RS sequence for different transmitters is generated using a base RS repetitions and transmitter specific cover code. The RS for each transmitter is repeated at least the number of transmitters available. A transmitter specific block wise cover code is applied on the repeated sequence. FIG. 3D shows RS generation with cover code. For a base sequence of length Nᵣ and for Nₜ number of transmitters to be multiplexed, the length of each RS sequence of each transmitter is at least Nᵣ×Nₜ. The transmitter specific block wise cover codes are orthogonal to each other. The RS for each transmitter may be the same sequence obtained from a base sequence or different sequences, and sequences may be pi/2-BPSK, QPSK, PSK, or ZC sequences. The base sequence generation or the transmitter specific sequence may depend on the cell ID, transmitter specific ID, symbol index, scrambling ID, antenna port, and slot number. The block wise spreading codes may be a PN sequence, Hadamard codes or Walsh codes. The block wise spreading code may be obtained from one of m-sequences, PN sequences, Kasami. The transmitter specific RS to be used for channel estimation may have either RS-pre-fix or RS-post-fix or both RS-pre-fix and RS-post-fix.

Let the base sequence of each RS block be r(n) of size Nᵣ, where Nᵣ is the length of RS block to be used to generate RS for each transmitter. The number of transmitters that are multiplexed be Nₜ. Hence, the size of RS for each transmitter is Nᵣ×Nₜ. Considering a two-transmitter case, the length of the RS is 2×Nᵣ. The RS for first transmitter is given by

$${r}_{1} ( n ) = r ( n mod ( {N}_{r} \times 2 ) )$$

Similarly, the RS for the second user is given by

$${r}_{2} ( n ) = r ( n mod ( {N}_{r} \times 2 ) ) {e}^{i π ⌊ \frac{n}{{N}_{r}} ⌋}$$

$$Here , n = \{ 0 , 1 , 2 , 3 , … , {N}_{r} \times 2 \}$$

Here, └ ┘ is a flooring operation, where for a real number x, └x┘ gives the greatest integer, which is less than or equal to x. With this kind of RS structure defined for the two transmitters, the Fourier transform of RS of the first transmitter will occupy the even indices, while the Fourier transform of the RS of the second transmitter will occupy the odd indices.

In another case, where the orthogonal sequence is obtained using one of the sequences defined above, the block wise cover code for each user is given by b₁(n), and b₂(n) of length Nₜ. With base RS block sequence being r(n), the RS sequence for each is given by

$${r}_{1} ( n ) = {b}_{1} ( ⌊ \frac{n}{{N}_{r}} ⌋ ) r ( n mod ( {N}_{r} \times 2 ) )$$

$${r}_{2} ( n ) = {b}_{2} ( ⌊ \frac{n}{{N}_{r}} ⌋ ) r ( n mod ( {N}_{r} \times 2 ) )$$

Here, └ ┘ is a flooring operation, where for a real number x, └x┘ gives the greatest integer, which is less than or equal to x.

In an embodiment, the control payload is processed in a similar way to the conventional 5G system before multiplexing data and RS, which involves code block segmentation (only when needed), the addition of CRC bits, channel coding, rate matching and code block concatenation, scrambling.

One embodiment of the present disclosure is a MIMO transmitter with Pre-DFT RS for multiplexed PUCCH and PUSCH. In this embodiment, the transmitter transmits more than one OTFDM symbols, each of which is comprising of at least one of at least one a data and at least one RS are transmitted in the same OFDM symbol. The at least one data is referred as the control data and User data. The at least one RS is referred as the RS. The data and the RS are multiplexed before DFT-precoding in the time domain. The Data and RS are sequence of samples. The position of RS may be in the center or starting or ending of the OFDM symbol. This kind of RS may be referred as long/main/localized RS. To support better channel estimation either cyclic pre-fix (RS-CP) or cyclic post-fix (RS-CS) or both pre-fix and post-fix will be added to the RS in the time domain. The sequence to be used as RS is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes.

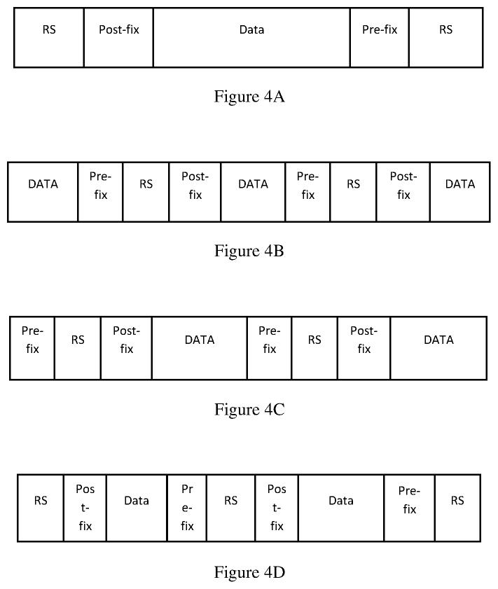

FIG. 4A shows a symbol with two RS blocks at the symbol boundaries and data in the middle of OFDM symbol. FIG. 4B shows a Symbol with RS with pre-fix and post-fix at ¼^{th} and ¾^{th} positions of OFDM symbol. FIG. 4C shows a Symbol with RS with pre-fix and post-fix starting at 0^{th} and ½^{th} positions of OFDM symbol. FIG. 4D shows a Symbol with two RS blocks at the symbol boundaries, one in the middle for channel estimation. The RS block occupies any positions in the symbol, like shown the FIGS. 4A to 4D, which are for 2 blocks and 3 blocks. However, it may be extended to any number of blocks and any other configuration. RS in each block may be the same sequence or different. This kind of each RS block may be referred as long/main/localized/primary RS block, and all the blocks will either have both RS pre-fix and RS-post-fix or RS-post-fix or RS-pre-fix. Each block will be used for channel estimation and the transmitter data followed by the block will be equalized with the channel that is estimated.

The same RS can be employed for demodulation of both Control data and user data, i.e. the channel estimates derived from the RS are used to equalize both Control and user data. In the case of multiple User transmissions, a dedicated RS port is allocated to each UE/transmitter and the RS across the ports are orthogonalized through CDM/FDM/TDM. Details of the same are given above. Also, control data of different transmitters are spreaded by employing 2 or 4 length spread codes. However, the user data is scrambled through UE/transmitter specific Identities, like nID, nSCID, RNTI, etc.

One embodiment of the present disclosure is a MIMO transmitter with Pre-DFT RS for PUSCH. The MIMO transmitter transmits more than one OTFDM symbols, each of which is comprising of at least one of at least one a data and at least one RS are transmitted in the same OTFDM symbol. The at least one data is referred User data which also includes the control data of the user piggybacked along with the user data. The at least one RS is referred as the RS. The data and the RS are multiplexed before DFT-precoding in the time domain. The data and RS are sequence of samples. The position of RS may be in the center or starting or ending of the OFDM symbol. This kind of RS may be referred as long/main/localized RS. To support better channel estimation either cyclic pre-fix (RS-CP) or cyclic post-fix (RS-CS) or both pre-fix and post-fix will be added to the RS in the time domain. The sequence to be used as RS is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes.

In the case of multiple User transmissions, a dedicated RS port is allocated to each UE/transmitter and the RS across the ports are orthogonalized through CDM/FDM/TDM. Details of the same are given above. However, the User data is scrambled by means of UE/Transmitter specific Identities, like nID, nSCID, RNTI, etc. Prior to data and RS multiplexing, the user payload is processed in a similar way to the conventional 5G system, which involves code block segmentation (Only when needed), the addition of CRC bits, channel coding, rate matching and code block concatenation, layer mapping, scrambling.

One embodiment of the present disclosure is a pre-DFT Sequence selection-based control data transmission. The transmitter transmits more than one OTFDM symbols, each of which is comprising of at least one of UE/transmitter specific sequence. The UE/transmitter specific sequence conveys 1 or 2 bits of UE control data implicitly. The UE specific sequence is DFT precoded before transmission. In an embodiment, the RS is not transmitted so the Base Station receiver uses non-coherent detection to extract the control data. Each UE is allocated a specific sequence to transmit, this sequence has length 12 so there is a single entry for each subcarrier. The UE transfers control information by applying a UE specific cyclic shift αᵢ to the base sequence. The Base Station identifies the cyclic shift and subsequently deduces the corresponding information content. The sequence to be used as base sequence is one of pi/2-binary phase shift keying (BPSK), a Quadrature Phase Shift Keying (QPSK), M-ary Phase Shift Keying (PSK), and Zadoff-chu (ZC) sequence. The sequences may be obtained using one of m-sequences, Pseudo-Noise (PN) sequences, Kasami, Walsh, and Hadamard codes.

One embodiment of the present disclosure is a method for transmitting one or more PUCCH-PUSCH Orthogonal time frequency-division multiplexing (OTFDM) symbols or one or more OTFDM symbols. The order in which the method steps is described is not intended to be construed as a limitation, and any number of the described method steps can be combined in any order to implement the method. Additionally, individual method steps may be deleted from the methods without departing from the scope of the subject matter described herein. Furthermore, the method can be implemented in any suitable hardware, software, firmware, or combination thereof.

The method comprising time-multiplexing, by the transmitter, at least one of a physical uplink control channel (PUCCH) sequence, a Physical Uplink Shared Channel (PUSCH) sequence and a reference sequence (RS) to generate a multiplexed sequence. Thereafter, generating one or more PUCCH-PUSCH Orthogonal time frequency-division multiplexing (OTFDM) symbols, which are referred to as OTFDM symbols, by processing the multiplexed sequence. The generated OTFDM symbols are transmitted using the one or more antennas (not shown in the figure) of the transmitter. In an embodiment, the number of generated symbols is one. In an embodiment, the number of symbols generated are more than one.

The method of generating the one or more PUCCH-PUSCH OTFDM symbols by processing the multiplexed sequence comprising transforming the multiplexed sequence using a Discrete Fourier Transform (DFT) to generate a transformed multiplexed sequence. Also, the method comprises performing padding operation by prefixing the transformed multiplexed sequence with a first predefined number (N1) of subcarriers and post-fixing the transformed multiplexed sequence with a second predefined number (N2) of subcarriers to obtain an extended bandwidth transformed multiplexed sequence. The value of the N1 is at least zero, and value of the N2 is at least zero.

Further, the method comprises mapping the extended bandwidth transformed multiplexed sequence with at least one of localized and distributed subcarriers to generate a mapped extended bandwidth transformed multiplexed sequence. A shaping is performed on the mapped extended bandwidth transformed multiplexed sequence using a filter to obtain a shaped extended bandwidth transformed multiplexed sequence.

Furthermore, the method comprises performing an Inverse Fast Fourier Transform (IFFT) on the shaped extended bandwidth transformed multiplexed sequence to produce a time domain sequence. Thereafter, the method comprises processing the time domain sequence to generate one or more PUCCH-PUSCH OTFDM symbols or referred to as OTFDM symbols.

This generation of the one or more PUCCH-PUSCH OTFDM symbols by processing the time domain sequence comprises performing at least one of addition of symbol cyclic prefix, addition of symbol cyclic suffix, phase compensation for each symbol by multiplying with a symbol specific exponential value, windowing, weighted with overlap and add operation (WOLA), bandwidth parts (BWP) rotation, additional time domain filtering, sampling rate up-conversion to match DAC rate and frequency shifting on the time domain waveform, to generate the one or more PUCCH-PUSCH OTFDM symbols.

In an embodiment, the time multiplexing is performed on at least one of the PUCCH sequence and the RS. The time multiplexed sequence is processed through the OTFDM symbol generating unit 104 to generate one or more PUCCH OTFDM symbols. The one or more transmitters is one of spatially multiplexed transmitters and uplink users.

In an embodiment, the time multiplexing is performed on at least one of the PUSCH sequence and the RS. The time multiplexed sequence is processed through the OTFDM symbol generating unit 104 to generate one or more PUSCH OTFDM symbols.

The RS comprises a base RS sequence, and at least one a RS CP and a RS CS. In an embodiment, the PUCCH sequence comprises one of a format 0 sequence, format 1 sequence, and format 2 sequence.

The format 0, also referred as PUCCH format 0, is a short format that can transmit up to two bits. It is used for transmitting acknowledgments and scheduling requests. The sequence selection is bias for PUCCH format 0. In this format 0, RS is not sent, so the Base Station receiver uses non-coherent detection to extract control data. Each UE is assigned a specific sequence of length M Mϵ{12,18,24}, with one entry per subcarrier. To transfer control information, the UE applies a UE-specific cyclic shift α_i to the base sequence. The Base Station detects the cyclic shift and infers the corresponding control information. The base sequence can be pi/2-binary phase shift keying (BPSK), Quadrature Phase Shift Keying (QPSK), M-ary Phase Shift Keying (PSK), or Zadoff-chu (ZC) sequence.

The format 1, also referred as PUCCH format 1, is a format that can transmit up to two bits. It uses a varying number of OFDM symbols, ranging from 4 to 14 symbols, with each symbol occupying one resource block in the frequency domain. The information bits to be transmitted are either BPSK or QPSK modulated, depending on whether one or two bits are being transmitted, respectively. These modulated bits are then multiplied by a low-PAPR sequence of length M, where M can be 12, 18, 24, and so on. Sequence and cyclic shift hopping techniques can be applied to introduce randomness and minimize interference.

The resulting modulated sequence of length M is spread in a block-wise manner using an orthogonal DFT code. This use of an orthogonal code in the time domain increases the capacity to accommodate multiple devices. Even if multiple devices have the same base sequence and phase rotation, they can still be separated by employing different orthogonal codes. Also, reference signals are inserted in the time domain along with the control sequence. Additionally, the reference sequences are spread in a block-wise fashion using an orthogonal sequence and then mapped to the OTFDM (Orthogonal Time Frequency Division Multiplexing) symbols. Therefore, the length of the orthogonal code, along with the number of cyclic shifts, determines the number of devices that can transmit using PUCCH format 1 on the same resource.

The format 2, also referred as PUCCH format 2, is a short format used for transmitting more than two bits of information. It is commonly used for simultaneous CSI reports and hybrid-ARQ acknowledgments, or when a larger number of hybrid-ARQ acknowledgments need to be transmitted. For larger payloads, a CRC (Cyclic Redundancy Check) is added. The control information, after the CRC is attached, is then encoded using Reed-Muller codes for payloads up to 11 bits. For larger payloads, Polar coding is used instead. After encoding, the data is scrambled and modulated using QPSK modulation.

The scrambling sequence used for randomization is based on the C-RNTI (Cell Radio Network Temporary Identifier) along with the physical-layer cell identity or a configurable virtual cell identity. This ensures that interference is randomized across cells and user equipment (UEs) that are utilizing the same set of time-frequency resources. The modulated QPSK symbols are then mapped to subcarriers across multiple resource blocks, using one or two OFDM symbols. In each OFDM symbol, a pseudo-random Pi/2-BPSK or QPSK sequence is mapped along with the control data, serving as a demodulation reference signal to facilitate coherent reception at the base station.

In an embodiment, the PUSCH sequence includes a PUSCH data sequence and Phase Tracking Reference signal (PT-RS). In an embodiment, the RS is at least one of a DMRS, a PT-RS and a SRS.

The at least one control sequence is one of a pi/2 binary phase shift keying (BPSK) sequence, a BPSK sequence and a Quadrature Phase Shift Keying (QPSK) sequence. In an embodiment, the control sequence includes HARQ acknowledgment, scheduling request (SR), and CSI. The control sequence is also referred to as control information or control data sequence.

The at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence. The at least one RS comprise a plurality of samples. The at least one of the plurality of RS samples is multiplexed with the at least one data samples.

The at least one RS comprises one or more transmitter specific RS associated with each of the one or more transmitters. Each of the one or more transmitter specific RS are orthogonal to each other in at least one of time, frequency, and code, in an embodiment. Each of the one or more transmitter specific is based on at least one of a transmitter specific RS antenna port.

The at least one RS is multiplied with one or more transmitter specific code covers to obtain one or more transmitter specific RS. Each of the one or more transmitter specific code covers are orthogonal to each other. In an embodiment, each of the one or more transmitter specific code covers is one of a binary phase shift keying (BPSK) sequence, a Walsh Hadamard sequence, PN sequences, a DFT sequence, and a phase ramp sequence.

Each of the one or more transmitter specific code cover is based on at least one of a transmitter specific RS antenna port, scrambling ID, symbol ID, slot number, and cell ID. The one or more transmitter specific RS is a sequence of samples, said each sample is multiplied with an element of a transmitter specific phase ramp sequence. Each of the one or more transmitter specific RS repetition is transmitter specific cyclic shifted sequence of the at least one RS's. In an embodiment, the number of one or more transmitter specific RS repetitions is at least zero.

The method also comprises performing cyclic shifting operation on the at least one RS, wherein the cyclic shifted RS is appended with at least one of a cyclic shifted RS pre-fix and a cyclic shifted RS post-fix. The RS is at least one of a DMRS, a PT-RS and a SRS.

In an embodiment of the present disclosure, a method for transmitting a PUCCH-PUSCH Orthogonal time frequency-division multiplexing (OTFDM) slot is provided. The method comprises time-multiplexing, by one or more transmitters, at least one of one or more PUCCH-PUSCH OTFDM symbols, one or more PUCCH OTFDM symbols and one or more PUSCH OTFDM symbols to generate an Orthogonal time frequency-division multiplexing (OTFDM) slot. In an embodiment, the OTFDM slot comprises one or more short PRACH formats

One embodiment of the present disclosure is a method for transmitting one or more PRACH Orthogonal time frequency-division multiplexing (OTFDM) symbols. The method being performed by a transmitter or communication system as shown in FIGS. 1D and 1E. The communication system comprises a plurality of transmitters or plurality of antennas, also referred to as one or more transmitters, or one or more antennas. The method comprises transforming at least PRACH sequence using a Discrete Fourier Transform (DFT) to generate a transformed sequence, followed by padding operation by prefixing the transformed multiplexed sequence with a first predefined number (N1) of subcarriers and post-fixing the transformed multiplexed sequence with a second predefined number (N2) of subcarriers to obtain an extended bandwidth transformed sequence.

Also, the method comprises mapping the extended bandwidth transformed multiplexed sequence with at least one of localized and distributed subcarriers to generate a mapped extended bandwidth transformed sequence. Further, the method comprises shaping the mapped extended bandwidth transformed multiplexed sequence using a filter to obtain a shaped extended bandwidth transformed sequence. Furthermore, the method comprises performing an Inverse Fast Fourier Transform (IFFT) on the shaped extended bandwidth transformed multiplexed sequence to produce a time domain sequence, and processing the time domain sequence to generate the one or more PRACH OTFDM symbols.

The processing of the time domain sequence to generate one or more PRACH OTFDM symbols comprises performing at least one of addition of symbol cyclic prefix, addition of symbol cyclic suffix, windowing, weighted with overlap and add operation (WOLA), bandwidth parts (BWP) rotation, additional time domain filtering, sampling rate conversion to match DAC rate and frequency shifting on the time domain waveform, to generate one or more PRACH OTFDM symbols. The PRACH sequence is one of pi/2 BPSK sequence and Zadoff-Chu (ZC) sequence.

One embodiment of the present disclosure is a method for transmitting an uplink frame. The method comprises multiplexing, by one or more transmitters, at least one of: one or more PRACH OTFDM symbols and one or more PUCCH-PUSCH OTFDM slots to generate at least one uplink signal associated with a beam.

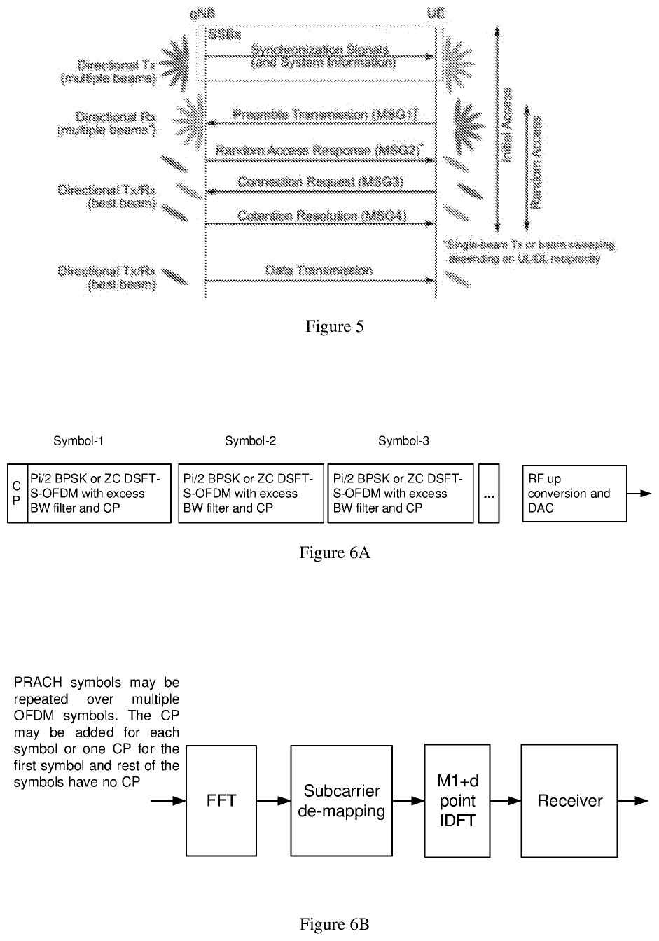

One embodiment of the present disclosure is uplink signalling. FIG. 5 shows an illustration of uplink signalling. As shown in FIG. 5, when a user equipment (UE) is initially entering the coverage area of a Base station (BS), it doesn't have any information about the Base station, like the carrier frequency (fc) used, the Bandwidth of the carrier, and the subcarrier spacing (SCS) employed, etc. The initial process of identifying the Base station by a UE to which it can communicate is termed a cell search. To facilitate the cell search procedure, the base station periodically broadcasts a specific type of signals known as Synchronization Signal Blocks (SSBs).

One important thing about NR SSB is the ability to use beam-sweeping for transmitting SS blocks. This means that SS blocks can be sent in different beams, one after the other. A group of SS blocks transmitted in this way is called an SS burst set. By using beam-forming for the SS block, the coverage area of each SS block transmission is expanded.

In beam-based systems, both the user equipment (UE) and gNodeB (gNB) have to find the most suitable beam for communication when they first connect. The gNB uses directional beams for transmitting and receiving signals within the cell. It sends out SS/PBCH blocks using different indices on various beams. When a UE is turned on, it listens to these SS/PBCH blocks while scanning across its receiving beams. The UE identifies an SS/PBCH block index with a power level that surpasses a predefined threshold called rsrp-ThresholdSSB, which is set by higher-level parameters.

This process determines which pair of beams the gNB and UE will use to communicate with each other. The UE sends a preamble based on the chosen SS/PBCH block index, using a beam determined by the beam it used to receive the SS/PBCH block. The gNB receives the preamble and decides on the most optimal beam to communicate with the UE. From that point onwards, both transmitting and receiving data between the gNB and UE occur using the same pair of beams.

Once the UE has acquired downlink synchronization through SSB and has successfully decoded the System Information Block (SIB-1), UE will initiate the random access procedure by transmitting a specific signal called random access preamble over Physical Random Access Channel (PRACH).

The random access preamble transmission is based on OTFDM waveform, where the PRACH preamble is DFT precoded followed with bandwidth extension and spectrum shaping. When the UE transmits the preamble to the gNB, it conveys the selected SS/PBCH block index to the gNB, so that subsequent transmissions from the gNB to that UE use the same beam corresponding to the selected SS/PBCH block. This is conveyed by the preamble index and the PRACH occasion used to transmit the preamble.

After the gNB successfully detects the preamble sent by the UE, it sends a random access preamble identifier (RAPID) along with a random access response (RAR). The UE then checks if the received RAPID matches the sequence it had selected as its preamble. If they match, it means that the random access response has been received successfully. The RAR, which follows the RAPID, contains various important details for the UE, including timing advance, uplink scheduling grant, and UE identity.

The random access response (RAR) is transmitted by the gNB is on the physical downlink shared channel {PDSCH). Information sent on the physical downlink control channel (PDCCH) makes it possible to identify the resource blocks that carry the response.

After receiving all the necessary information from the random access response (RAR), the UE can now utilize the allocated uplink resources to send its Msg3 on the uplink shared channel (PUSCH). Using Msg3, the UE sends an RRCSetupRequest to the network, which triggers the initiation of the initial attach procedure towards the 5G core network. RRC connection establishment starts with the UE sending an RRCSetupRequest as a Msg3 PUSCH transmission to the network.

In our proposal, we consider UE employs PUSCH-OTFDM waveform to transmit Msg-3, where the Msg-3 data is multiplexed with RS in time domain followed with DFT precoding, bandwidth expansion and spectrum shaping.

The corresponding response from the network is transmission of the RRCSetup message or RRCReject message, and the same is transmitted on the downlink shared channel PDSCH. This is often termed as Msg-4.

The connection setup message is acknowledged by the UE by sending an RRCSetupComplete message back to the network. In the present disclosure, considering that UE employs PUS\CCH-OTFDM waveform to transmit Msg-4 acknowledgement (ACK/NACK), where the Msg-3 data is multiplexed with RS in time domain followed with DFT precoding, bandwidth expansion and spectrum shaping.

One embodiment of the present disclosure is an uplink (UL) transmitter or communication system. The transmitter comprises a time division multiplexer (TDM) performing time multiplexing within one OFDM Symbol, multiple RS within the symbol, in accordance with an embodiment of the present disclosure. The multiplexing of multiple RS blocks and data blocks in one OFDM symbol is performed. The RS blocks may comprise of one or more long RS blocks and one or more short RS blocks. Long RS blocks facilitate estimation of complete IR and equalization of the neighbour data/control chunks, whereas short RS blocks facilitate phase tracking and compensation within a OFDM symbol. Multiple long RS blocks are used to facilitate equalization of the neighbouring data/control chunks so that channel variations caused by the mobile radio channel within one symbols are compensated.

In another embodiment, an uplink (UL) transmitter comprising a TDM performs multiplexing within an OFDM Symbol. The method of multiplexing is performed on at least one of PUSCH data and RS, PUCCH data and RS, PUCCH format-0 sequence in one OFDM symbol. The PUSCH data and RS may be one or more chunks, PUCCH data and RS may be one or more chunks. This single symbol structure enables transmission of information with extremely low latency. Higher latency slots may be constructed by mapping data/control and RS over multiple OFDM symbols as well. When multiple uplink channels are multiplexed in time in single OFDM symbol, data corresponding to each user is consider as an independent data chunk. To avoid leakages of one channel on to the other at the receiver, data chunk corresponding to the channels are added with post-fix and pre-fix.

One embodiment of the present disclosure is Multi-user multiplexing in one symbol. The PUCCH/PUSCH transmission data/control information of multiple users is multiplexed by using spreading user data/control/RS using orthogonal spreading codes. This method has the advantage of transmitting data/control information with low latency by sharing a single OFDM symbol among multiple users. For PUCCH/PUSCH, base RS such as pi/2 BPSK or ZC that is cell specific. Circularly shifted version of the base RS is used within a cell where each uses applies a distinct value of the shift. The circularly shifted sequences are orthogonal to the base sequence.

One embodiment of the present disclosure is PRACH in one symbol. A single symbol PRACH is one of a pi/2 BPSK and ZC base sequence. The sequence is applied to the DFT, excess subcarriers are added to the DFT output followed by the spectrum shaping filter, IFFT and followed by processing. A base pi/2 BPSK or ZC is determined by the cell ID, and user specific circular shifts are applied on the base sequence to determine the sequence.

FIG. 6A shows a block diagram of a PRACH receiver. In an embodiment the PRACH symbols may be repeated over multiple OFDM symbols. The CP may be added for each symbol or one CP for the first symbol and rest of the symbols have no CP. The one symbol PRACH may be repeated over multiple symbols as shown in FIG. 6B. The FIG. 6B shows an illustration contiguous repetitions of symbols in of UL PRACH transmitter.

Further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

A description of an embodiment with several components in communication with each other does not imply that all such components are required. On the contrary a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description. Accordingly, the disclosure of the embodiments of the invention is intended to be illustrative, but not limiting, of the scope of the invention.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A method for transmitting one or more PUCCH-PUSCH Orthogonal time frequency-division multiplexing (OTFDM) symbols, comprising:
time-multiplexing, by one or more transmitters, at least one of a physical uplink control channel (PUCCH) sequence, a Physical Uplink Shared Channel (PUSCH) sequence and a reference sequence (RS) to generate a multiplexed sequence; and
generating, by the one or more transmitters, one or more PUCCH-PUSCH OTFDM symbols by processing the multiplexed sequence.

2. The method as claimed in claim 1, wherein the time multiplexing is performed on at least one of the PUCCI sequence and the RS.

3. The method as claimed in claim 2, wherein the time multiplexed sequence is processed to generate one or more PUCCH OTFDM symbols.

4. The method as claimed in claim 1, wherein the time multiplexing is performed on at least one of the PUSCH sequence and the RS.

5. The method as claimed in claim 4, wherein the time multiplexed sequence is processed to generate one or more PUSCH OTFDM symbols.

6. The method as claimed in claim 1, wherein the RS comprises a base RS sequence, and at least one a RS CP and a RS CS.

7. The method as claimed in claim 1, wherein the PUCCH sequence comprises one of a format 0 sequence, format 1 sequence, and format 2 sequence.

8. The method as claimed in claim 1, wherein the PUSCH sequence includes a PUSCH data sequence and Phase Tracking Reference signal (PT-RS).

9. The method as claimed in claim 1, wherein generating the one or more PUCCH-PUSCH OTFDM symbols by processing the multiplexed sequence comprising:
transforming the multiplexed sequence using a Discrete Fourier Transform (DFT) to generate a transformed multiplexed sequence;
performing padding operation by prefixing the transformed multiplexed sequence with a first predefined number (NI) of subcarriers and post-fixing the transformed multiplexed sequence with a second predefined number (N2) of subcarriers to obtain an extended bandwidth transformed multiplexed sequence;
mapping the extended bandwidth transformed multiplexed sequence with at least one of localized and distributed subcarriers to generate a mapped extended bandwidth transformed multiplexed sequence;
shaping the mapped extended bandwidth transformed multiplexed sequence using a filter to obtain a shaped extended bandwidth transformed multiplexed sequence;
performing an Inverse Fast Fourier Transform (IFFT) on the shaped extended bandwidth transformed multiplexed sequence to produce a time domain sequence; and
processing the time domain sequence to generate the one or more PUCCH-PUSCH OTFDM symbols.

10. The method as claimed in claim 9, wherein value of the N1 is at least zero, and value of the N2 is at least zero.

11. The method as claimed in claim 9, wherein processing the time domain sequence to
generate one or more PUCCH-PUSCH OTFDM symbols comprises performing at least one of addition of symbol cyclic prefix, addition of symbol cyclic suffix, windowing, weighted with overlap and add operation (WOLA), bandwidth parts (BWP) rotation, additional time domain filtering, sampling rate conversion to match DAC rate and frequency shifting on the time domain waveform, to generate one or more PUCCH-PUSCH OTFDM symbols.

12. The method as claimed in claim 1, wherein the one or more transmitters is one of spatially multiplexed transmitters and uplink users.

13. The method as claimed in claim 1, wherein the at least one control sequence is one of a pi/2 binary phase shift keying (BPSK) sequence, a BPSK sequence and a Quadrature Phase Shift Keying (QPSK) sequence.

14. The method as claimed in claim 1, wherein the control sequence includes HARQ acknowledgment, scheduling request (SR), and CSL.

15. The method as claimed in claim 1, wherein the at least one RS is one of a pi/2 binary phase shift keying (BPSK) sequence, a BPSK sequence, a Zadoff-Chu (ZC) sequence, a Quadrature Phase Shift Keying (QPSK) sequence, and a M-ary Phase Shift Keying (PSK) sequence.

16. The method as claimed in claim 1, wherein the at least one RS comprise a plurality of samples, wherein at least one of the plurality of RS samples is multiplexed with the at least one data samples.

17. The method as claimed in claim 1, wherein the at least one RS comprises one or more transmitter specific RS associated with each of the one or more transmitters.

18. The method as claimed in claim 17, wherein each of the one or more transmitter specific RS are orthogonal to each other in at least one of time, frequency, and code.

19. The method as claimed in claim 17, wherein each of the one or more transmitter specific is based on at least one of a transmitter specific RS antenna port.

20. The method as claimed in claim 1, wherein the at least one RS is multiplied with one or more transmitter specific code covers to obtain one or more transmitter specific RS.

21-34. (canceled)
